(19) United States
(12) Patent Application Publication
(10) Pub. No.: US 2007/0230908 A1
(43) Pub. Date: Oct. 4, 2007

(54) Information recording medium playback apparatus, information recording medium playback method, and information recording medium

(75) Inventor: Ryuichi Kitajima, Funabashi-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/723,323

(22) Filed: Mar. 19, 2007

(30) Foreign Application Priority Data
Apr. 3, 2006 (JP) 2006-102325

(51) Int. Cl. H04N 7/00

(52) U.S. Cl. 386/95

(57) ABSTRACT

According to one embodiment, an information recording medium playback apparatus of the invention comprises an interrupt specifying section, an interrupt position information holding section, a playback resume specifying section which gives a playback resume instruction after the interruption, an interrupt position read control section which, when the playback resume instruction has been given, reads a specific management information pack at the interrupt position on the basis of the interrupt position information, a synchronous information referring section which refers to synchronous information included in the management information pack, a specific pack taking-in control section which takes in a specific pack from a position ahead of the interrupt position, referring to the synchronous information, and a playback processing section which reproduces not only the data in the specific pack but also the data in the pack from the interrupt position.

### CROSS-REFERENCE TO RELATED APPLICATIONS

This application is based upon and claims the benefit of priority from Japanese Patent Application No. 2006-102325, filed Apr. 3, 2006, the entire contents of which are incorporated herein by reference.

### BACKGROUND

1. Field

One embodiment of the invention relates to an information recording medium playback apparatus, an information recording medium playback method, and an information recording medium, and more particularly to improvements in the operation of resuming the playback accurately after the interruption.

2. Description of the Related Art

In recent years, Digital Versatile Discs (DVDs) and their playback units have been widely used. Moreover, a High-Definition DVD (a High-Density DVD or a so-called HD DVD) which can perform high-density recording and high-quality recording has been developed.

Generally, a disc playback unit is provided with a resume function (refer to Jpn. Pat. Appln. KOKAI Publication No. 10-97766). The resume function is to store playback position information in the playback management information as resume information into a memory, when the disc is stopped in the middle of playback, when the disc is ejected, or when the power supply of the playback unit is turned off. Then, when a play operation is carried out again, or when the disc is installed in the playback unit again and a play operation is performed, the resume information is used as start position information for the start of playback.

In the case of the HD DVD, the resume function requires special consideration in terms of the structure of its data format and its large amount of data. Even when information on the interrupt position at which playback was interrupted is simply stored as in a conventional way and the information on the interrupt position is processed at the time of resumption of playback as is conventionally done, the desired playback may not be obtained.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram showing the configuration of an information recording medium playback apparatus to which the invention has been applied;

FIG. 2 is a diagram to help explain the configuration of the volume space of a video disc according to an embodiment of the invention;

FIG. 3 is a diagram to help explain the volume space of FIG. 2 in more detail;

FIG. 4 is a diagram to help explain the video manager information (VMGI) of FIG. 3 in more detail;

FIG. 5 is a diagram to help explain the information in the title search pointer table (TT_SRPT) of FIG. 4 in more detail;

FIG. 6 is a diagram to help explain the title search pointer table information (TT_SRPTI) of FIG. 5 in more detail;

FIG. 7 is a diagram to help explain the information in the title search pointer (TT_SRP#n) for titles of FIG. 5 in more detail;

FIG. 8 is a diagram to help explain the video title set information (VTSI) of FIG. 3 in more detail;

FIG. 9 is a diagram to help explain the information in the video title set part-of-title search pointer table (VTS_PTT_SRPT) of FIG. 8 in more detail;

FIG. 10 is a diagram to help explain the part-of-title search pointer table information (PTT_SRPTI) of FIG. 8 in more detail;

FIG. 11 is a diagram to help explain the information in the title unit search pointer (TTU_SRP#n) of FIG. 9 in more detail;

FIG. 12 is a diagram to help explain the information in the part-of-title search pointer (PTT_SRP#n) of FIG. 9 in more detail;

FIG. 13 is a diagram to help explain the information in the video title set program chain information table (VTS_PGCIT) of FIG. 9 in more detail;

FIG. 14 is a diagram to help explain the video title set program chain information (VTS_PGCI) of FIG. 13 in more detail;

FIG. 15 is a diagram to help explain the information in the program chain program map (PGC_PGCMAP) of FIG. 14 in more detail;

FIG. 16 is a diagram to help explain the information in the cell playback information table (C_PBIT) of FIG. 15 in more detail;

FIG. 17 is a diagram to help explain the cell playback information (C_PBI) of FIG. 16 in more detail;

FIG. 18 is a diagram to help explain the information in the cell position information table (C_POSIT) of FIG. 15 in more detail;

FIG. 19 is a diagram to help explain a hierarchy of contents of a video object;

FIG. 20 is a diagram to help explain the configuration of a navigation pack (NV_PCK) included in a video object;

FIG. 21 is a diagram to help explain the configuration of data search information (DSI) in the navigation pack (NV_PCK) of FIG. 20;

FIG. 22 is a diagram to help explain the configuration of general information (DSI_GI) in the data search information (DSI) of FIG. 21;

FIG. 23 is a diagram to help explain the configuration of synchronous information (SYNCI) in the data search information (DSI) of FIG. 21;

FIG. 24 is a diagram to help explain the configuration of a sub-picture data unit;

FIG. 25 is a diagram to help explain the configuration of a highlight pack;

FIG. 26 is a diagram to help explain the configuration of the data in a highlight pack;

FIG. 27 is a diagram to help explain the configuration of highlight information (HLI) composed of the data in a highlight pack;

FIG. 28 shows an example of an image composed of a main picture, a sub-picture, and a highlight;

FIG. 29 is a block diagram showing characteristic parts of an apparatus according to the invention;

FIG. 30 is a flowchart to help explain the operation of the apparatus in FIG. 29; and

FIG. 31 shows an example of data allocation on a disc to help explain the operation of the apparatus in FIG. 29.

### DETAILED DESCRIPTION

Various embodiments according to the invention will be described hereinafter with reference to the accompanying drawings.

It is an object of one embodiment to provide an information recording medium playback apparatus, an information recording medium playback method, and an information recording medium which are configured to achieve an exact operation when playback is resumed after the interruption of playback.

According to an aspect of the embodiment, there is provided an information recording medium playback apparatus comprising: an interrupt specifying section which specifies the interruption of playback of the contents of a disc; an interrupt position information holding section which holds interrupt position information on the interrupt position on the disc when the interrupt specifying section has given an interrupt instruction; a playback resume specifying section which gives a playback resume instruction after the interruption; an interrupt position read control section which, when the playback resume instruction has been given, accesses the interrupt position on the basis of the interrupt position information and reads a specific management information pack; a synchronous information referring section which refers to synchronous information included in the management information pack; a specific pack taking-in control section which takes in a specific pack from a position ahead of the interrupt position, referring to the synchronous information; and a playback processing section which, after the specific pack has been taken in, reproduces not only the data in the specific pack but also the data in the pack from the interrupt position.

With the above configuration, the specific pack related to the playback signal from the interrupt position can be taken in, which makes it possible to output proper images.

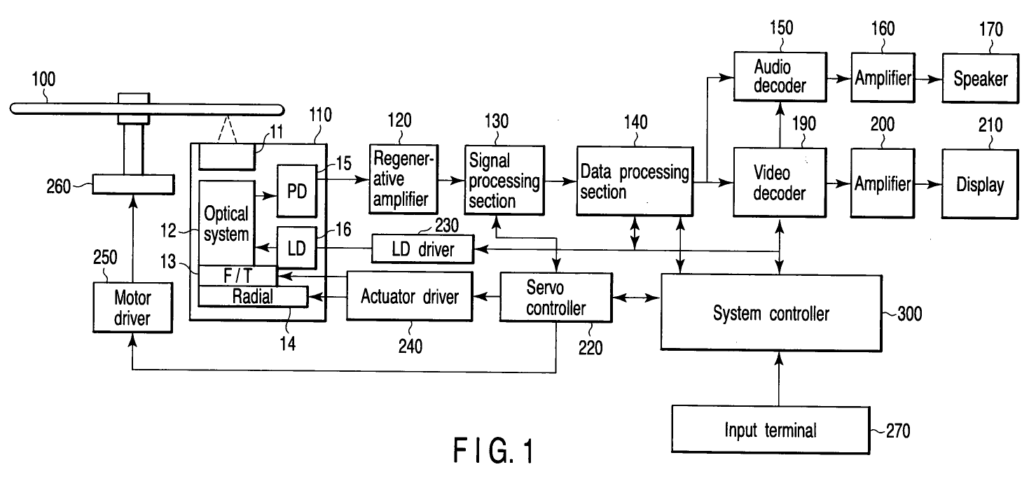

First, an overall configuration of an information recording medium playback apparatus will be explained with reference to FIG. 1.

A spindle motor 260 rotates a turntable. A clamper holds an optical disc 100 in place on the turntable. The spindle motor 260 is controlled by a motor driver 250.

An optical head 110 includes an objective lens 11 and an optical system 12. The optical system 12 is driven by a focus and tracking actuator 13. When the focus and tracking actuator 13 is controlled by an actuator driver 240, laser light focuses on a track on the optical disc and follows the track.

A radial actuator 14, which is for moving the optical head 110 radially over the disc, is controlled by the actuator driver 240.

The reflected light from the disc is taken out from the optical system 12 via the objective lens 11 and is converted into an electric signal at a photodetector 15. The electric signal is gain-controlled at a regenerative amplifier 120 and is input to a signal processing section 130. The signal processing section 130 performs demodulation, buffering, error correction, and others, and input the resulting signal to a data processing section 140. The data processing section 140 performs packet separation, control signal separation, and others and inputs audio information to an audio decoder 150 and video information to a video decoder 190. The output of the audio decoder 150 and that of a video decoder 190 are amplified at amplifiers 160, 200, respectively. The audio signal of the amplifier 160 is output to a speaker 170 and the video signal of the amplifier 200 is input to a display unit 210.

Using a focus error signal and a tracking error signal which are obtained by subjecting the playback signal from, for example, a 4-quadrant photodiode to arithmetic processing, a servo controller 220 supplies a control signal to an actuator (ACT) driver 240. The actuator driver 240 supplies a control signal to the radial actuator 14 and the focus and tracking actuator 13. This causes the laser beam emitted from the objective lens 11 to follow the track on the disc 100.

A system controller 300 controls the playback, stop, pause, and the like of the apparatus in response to the signal from an input terminal (e.g., a remote controller or an operation key input section) 270. The system controller 300 further controls a laser diode driver 230. The laser diode driver 230 drives a laser diode 16 mounted on the optical head 110, with the result that laser light is output.

When the optical disc 100 is installed in the DVD playback apparatus, the spindle motor 260 rotates up to a specific number of revolutions. Next, laser light is turned on, a periodical driving current is caused to flow, the optical head is moved up and down along the axis, and focusing-on is done. Thereafter, tracking-on is done and the data is read from the disc.

<Explanation of a Data Structure of the Disc>

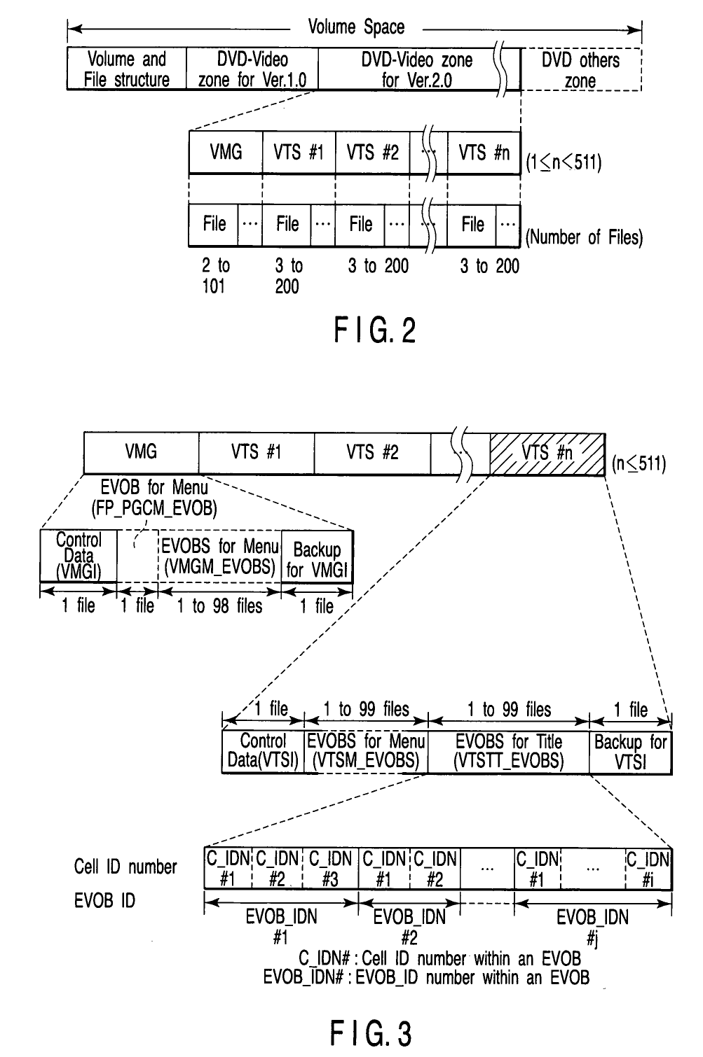

FIG. 2 shows a volume space configured logically on a disc. The volume space includes “DVD-Video zone for Ver. 1.0” and “DVD-Video zone for Ver. 2.0” as video zones. “DVD-Video zone for Ver. 2.0” includes one video manager (VMG) and a plurality of video title sets (VTSs). Each of the video manager (VMG) and a video title set (VTS) is composed of a plurality of files.

FIG. 3 shows the video manager (VMG) and video title sets (VTSs) using much deeper hierarchical levels. The video manager (VMG) includes video manager information (VMGI) as control data, an enhanced video object set (EVOBS for Menu (VMGM_EVOBS) for a menu of the video manager, and a backup for VMGI. The video title set (VTS) includes video title set information (VTSI) as control data, an enhanced video object set (EVOBS for Menu (VTSM_EVOBS)) for a menu of video title sets, an enhanced video object set (EVOBS for Title (VTSTT_EVOBS)) for titles, and a backup files for VTSI.

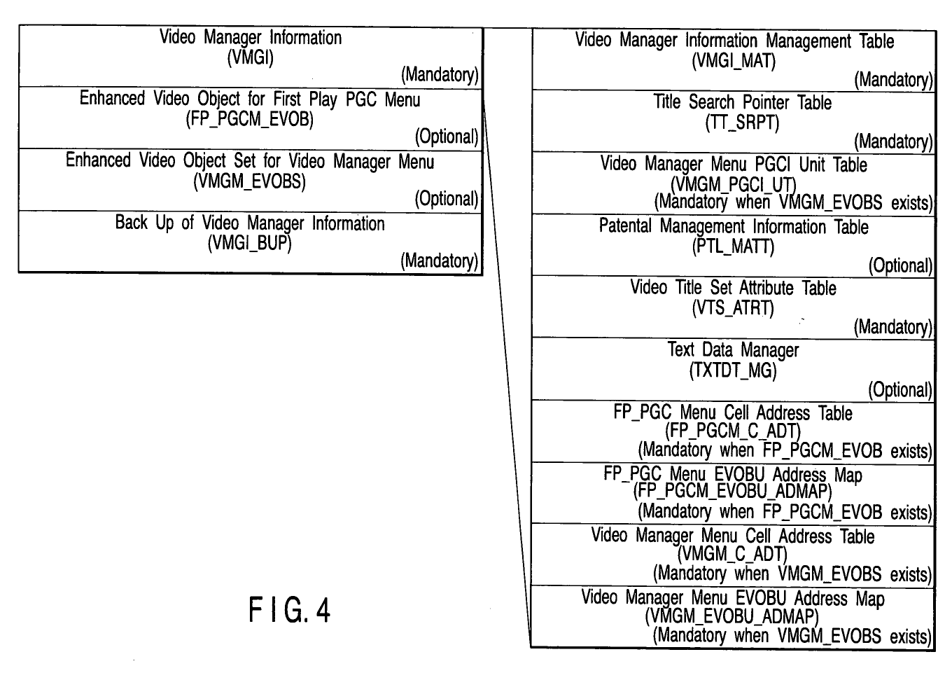

FIG. 4 shows video manager information (VMGI) in VMG. VMGI includes a title search pointer table (TT_SRPT) for searching for a title recorded on the disc. VMGI further includes information on parental management and a method related to attributes of video title sets.

VMGI begins with a manager information management table (VMGI_MAT), followed by a title search pointer table (TT_SRPT), a video manager menu PGCI unit table (VMGM_PGCI_UT), a parental management information table (PLT_MAIT), a video title set attribute table (VTS_ATRT), a text data manager (TXTDT_MG), an FP_PGC menu cell address table (FP_PGCM_C_ADT), an FP_PGC menu enhanced video object unit address map (FP_PGCM_EVOBU_ADMAP), a video manager menu cell address table (VMGM_C_ADT), and a video manager menu enhanced video object unit address map (VMGM_EVOBU_ADMA) in that order.

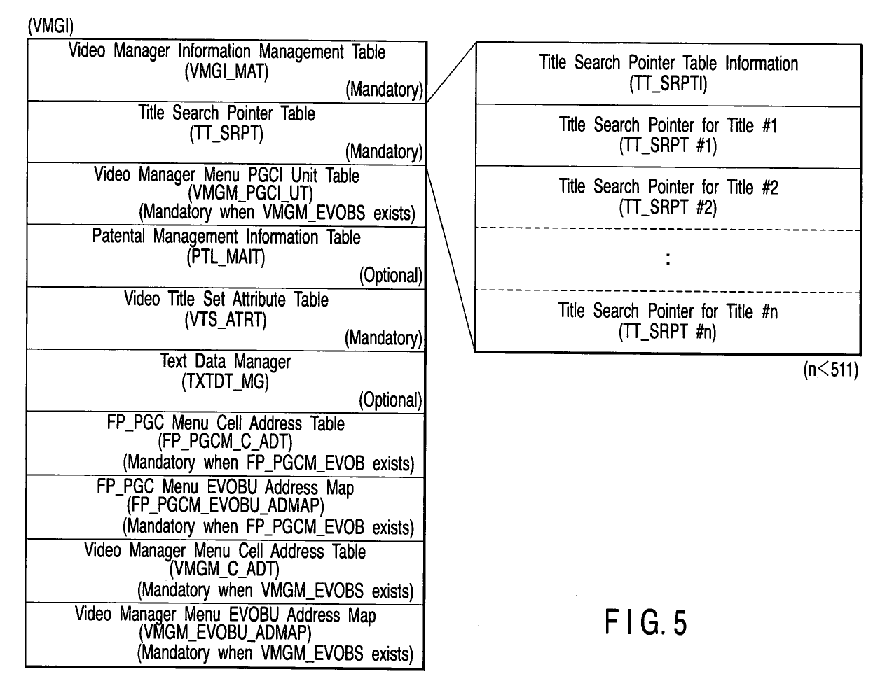

FIG. 5 shows the contents of the title search pointer table (TT_SRPT) in more detail. TT_SRPT includes title search pointer table information (TT_SRPTI) and title search pointer for titles #n (TT_SRP #n).

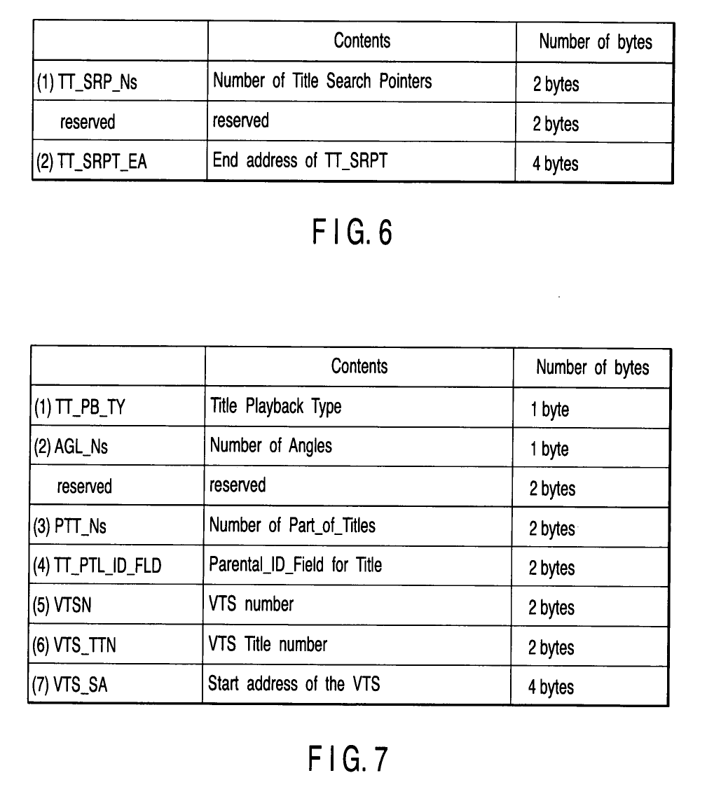

As shown in FIG. 6, in TT_SRPTI, the number of title search pointers (TT_SRP_Ns), the end address of the title search pointers (TT_SRPT_EA), and others have been written.

As shown in FIG. 7, in TT_SRP #n, the number of parts of titles (PTT_Ns) (corresponding to the number of chapters), the video title set number (VTS number (VTSN)), the video title set title number (VTS_TTN), the start address of the video title set (VTS_SA), and others have been written. Using the search pointer, the desired title can be reached.

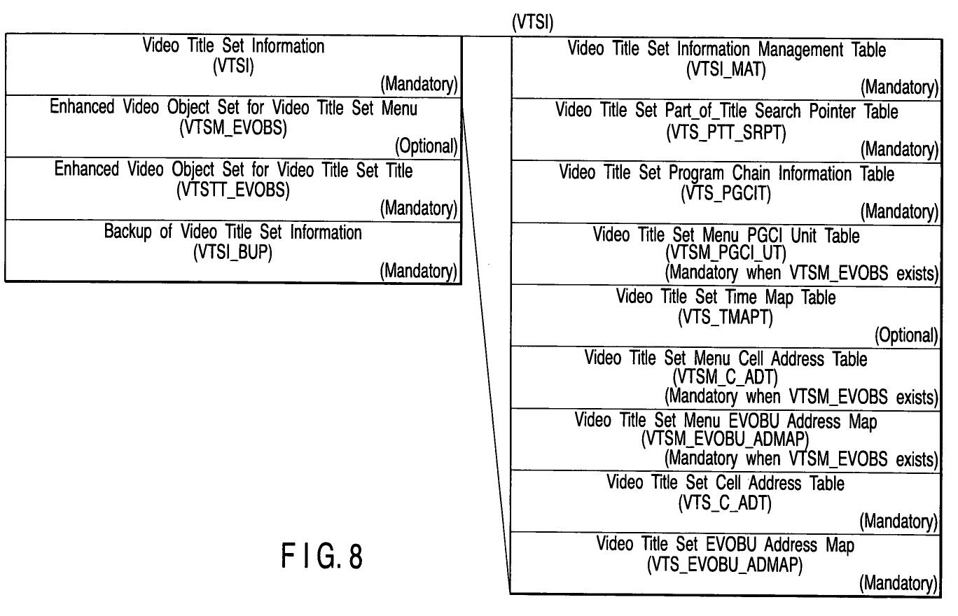

FIG. 8 shows the contents of video title set information in more detail. VTSI includes a video title set information management table (VTSI_MAT), a video title set title part search pointer table (Video Title Set Part_of_Title Search Pointer Table (VTS_PTT_SRPT)), a video title set program chain information table (VTS_PGCIT), a video title set menu PGCI unit table (VTSM_PGCI_UT), a video title set time map table (VTS_TMAPT), a video title set menu cell address table (VTSM_C_ADT), a video title set menu EVOBU address map (VTSM_EVOBU_ADMAP), a video title set cell address table (VTS_C_ADT), and a video title set EVOBU address map (VTS_EVOBU_ADMAP).

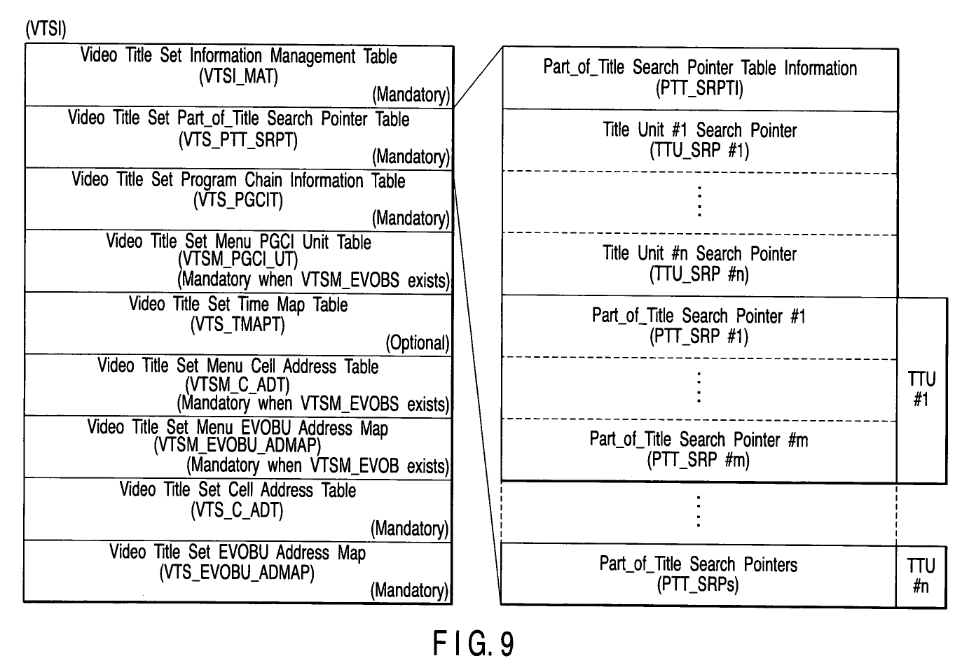

FIG. 9 shows the contents of the video title set title part search pointer table (=Video Title Set Part_of_Title Search Pointer Table (VTS_PTT_SRPT)) in more detail. The table can be used to search for parts of a video title, or chapters. In the table, title part search pointer table information (=Part_of_Title Search Pointer Table Information (PTT_SRPTI)) and title unit search pointer (TTU_SRP #n) have been written. Referring to TTU_SRP #n, a title unit (chapter) is determined and the search pointer for the title part is determined.

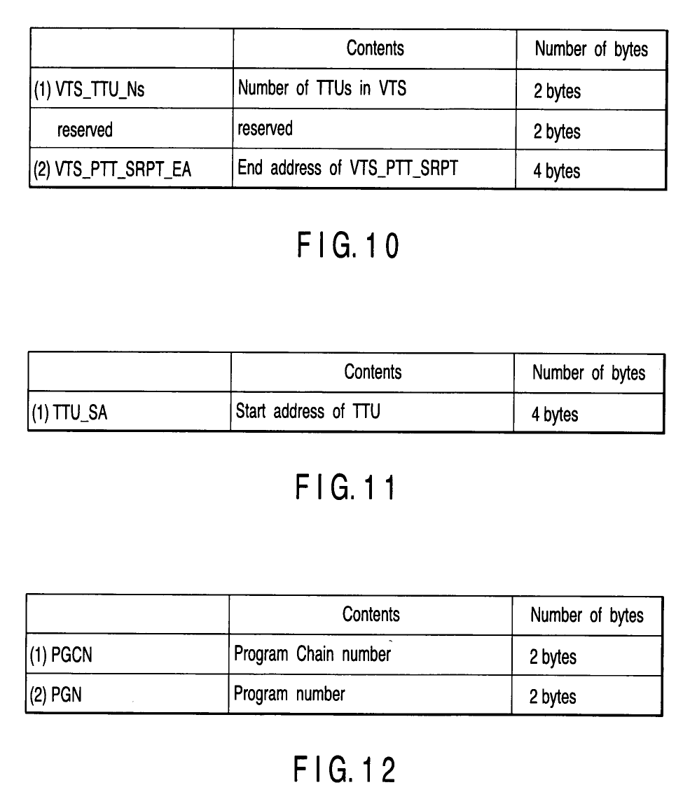

FIG. 10 shows the contents of the PTT_SRPTI. In the PTT_SRPTI, the number of TTUs in VTS (VTS_TTU_Ns) has been written. Further written in the PTT_SRPTI is the end address of the search pointer table (VTS_PTT_SRPT_EA).

FIG. 11 shows the contents of TTU_SRP#n. The contents are the start address of TTU#n. According to the start address, TTU#n is read. In TTU#n, PTT_SRP#1 to PTT_SRP#m can be recognized sequentially.

FIG. 12 shows the contents of PTT_SRP#m. In PTT_SRP #m, the program chain number describing the playback order of chapters in the video title set and the program number have been written.

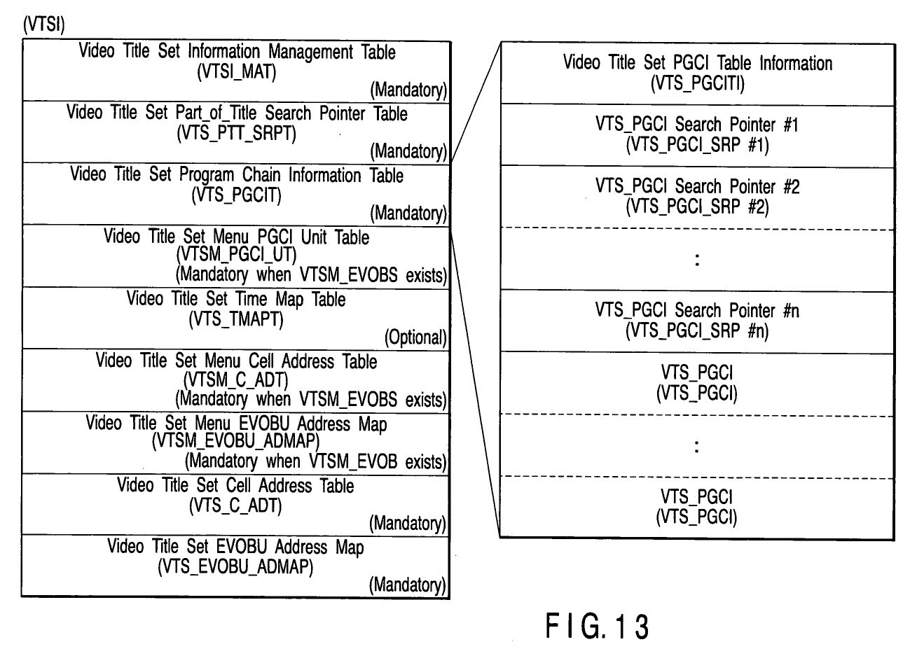

FIG. 13 shows the contents of a video tile set program chain information table (VTS_PGCIT) included in VTSI. VTS_PGCIT includes VTS_PGCIT information (VTS_PGCITI), video title set program chain information search pointer #n (VTS_PGCI_SRP #n), and VTS_PGCI accessible on the basis of the search pointer.

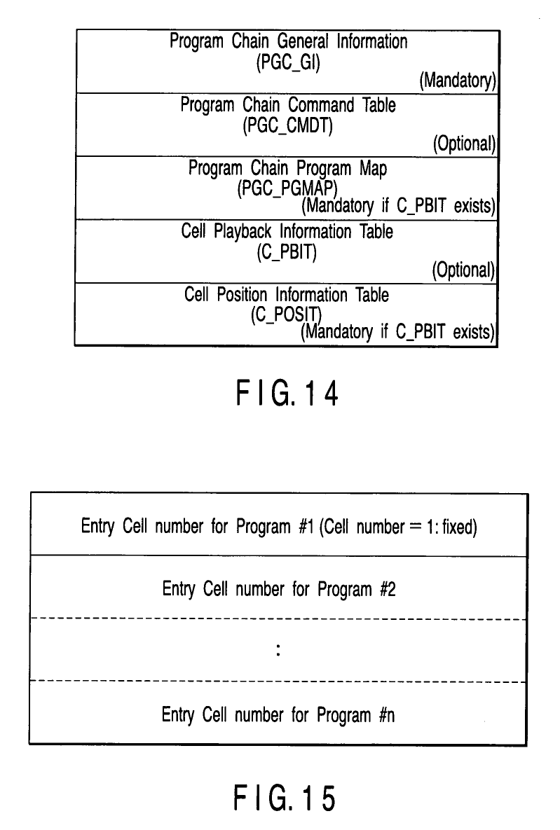

FIG. 14 shows the contents of the VTS_PGCI. The VTS_PGCI includes program chain general information (PGC_GI), a program chain command table (PCG_CMDT), a program chain program map (PGC_PGMAP), a cell playback table (C_PBIT), and a cell position information table (C_POSIT).

In PGC_GI, the number of programs specified in the program chain, the number of cells, the playback time, the operations allowed for user control, audio stream valid/invalid information, information on decoding, sub-picture stream valid/invalid information, and attributes have been written. In PGC_CMDT, a pre-command for executing processes in the apparatus before the processing of the program chain and a post-command for executing processes later in the apparatus have been written.

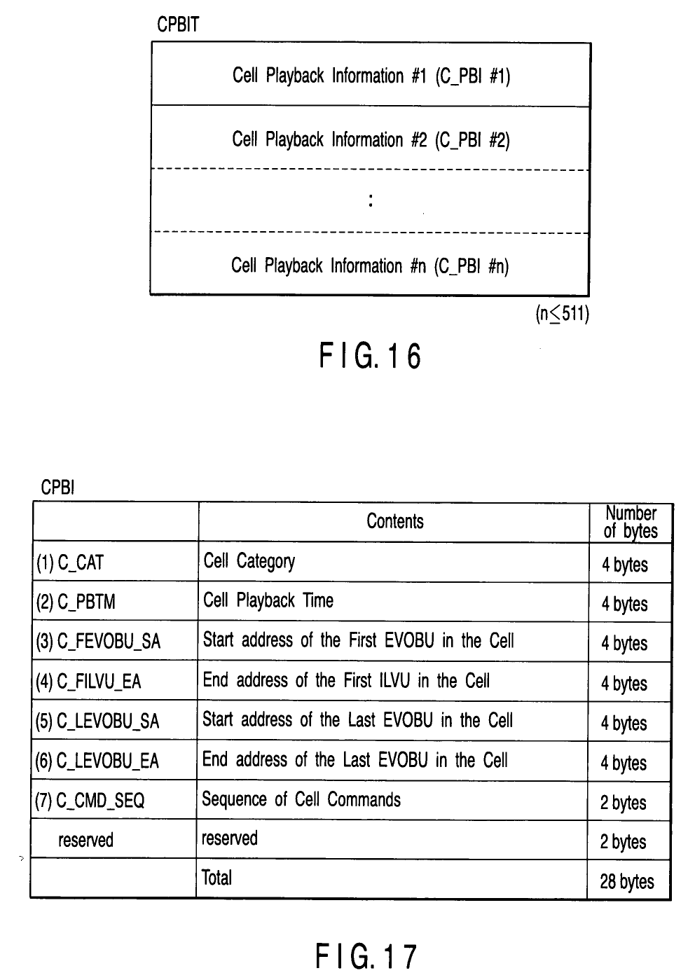

FIG. 15 shows the contents of PGC_PGMAP. In PGC_PGMAP, an entry cell number for each program has been written. FIG. 16 shows the contents of C_PBIT. FIG. 17 shows the contents of cell playback information (C_PBI).

Written in C_PBI are a cell category (C_CAT), cell playback time (C_PBTM), the start address of the first EVOBU in the cell (C_FEVOBU_SA), the end address of the first ILVU in the cell (C_FILVU_EA), the start address of the last EVOBU in the cell (C_LEVOBU_SA), the end address of the last LEVOBU in the cell (C_LEVOBU_EA), and the sequence of cell commands (C_CMD_SEQ).

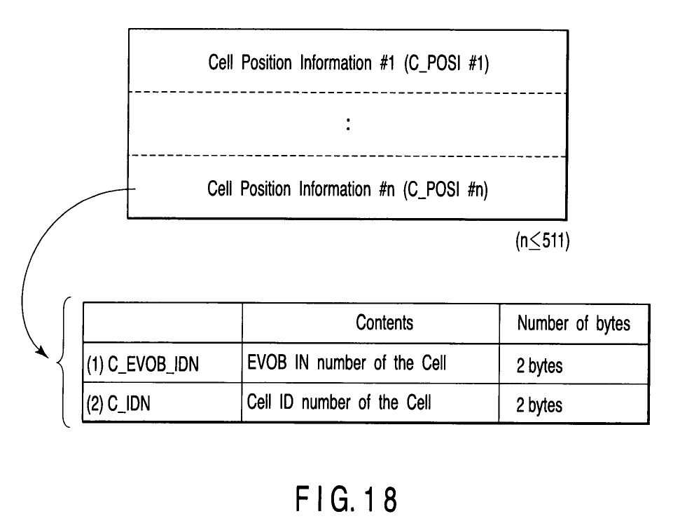

FIG. 18 shows cell position information #n (C_POSI#n). In C_POSI#n, the EVOB ID number of the cell (C_EVOB_IND) and the cell ID number of the cell (C_IND) have been written.

On the basis of the management information, the playback apparatus can access a desired position of the content recorded on the disc.

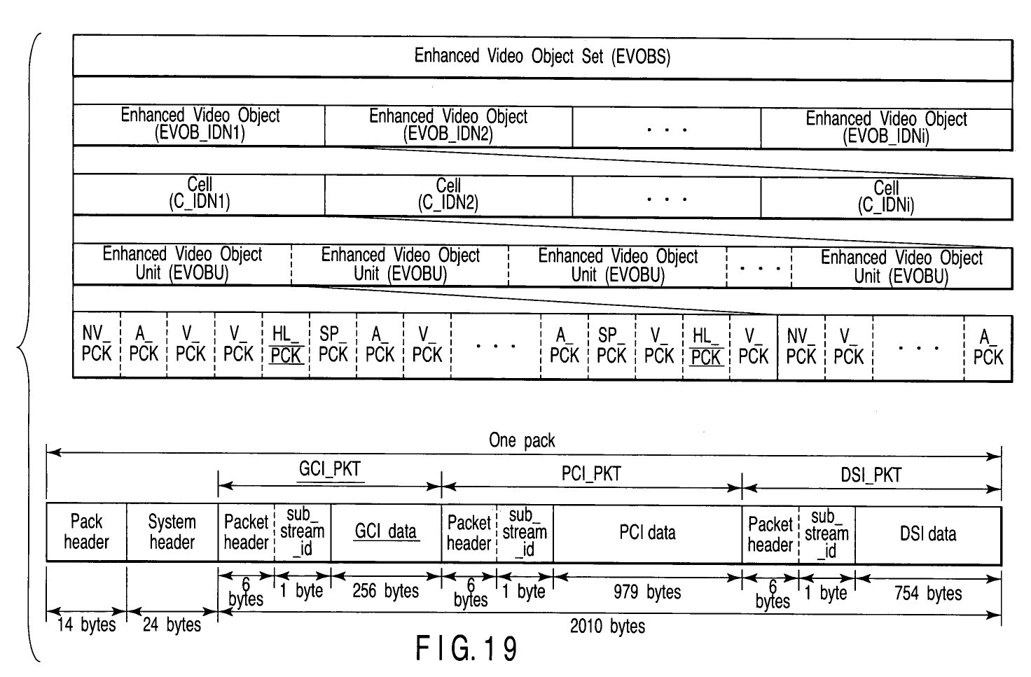

FIG. 19 shows a data configuration of an enhanced video object set (EVOBS). EVOBS includes one or more enhanced video objects. When there are two or more enhanced video objects, identification numbers are allocated to them (refer to EVOB_IDN1, . . . , EVOB_INDi). One EVOB includes one or more cells. When there are two or more cells, identification numbers are allocated to them (refer to C_IDN1, . . . , C_INDi). One cell includes one or more enhanced video object units (EVOBU). One EVOBU has a navigation pack (NV_PCK) at its head and includes an audio pack (A_PCK), a video pack (V_PCK), a highlight pack (HL_PCK), and a sub-picture pack (SP_PCK). In the audio pack, audio data is put in the data area. In the video pack, video data is put in the data area. In the sub-picture pack, sub-picture data is put in the data area.

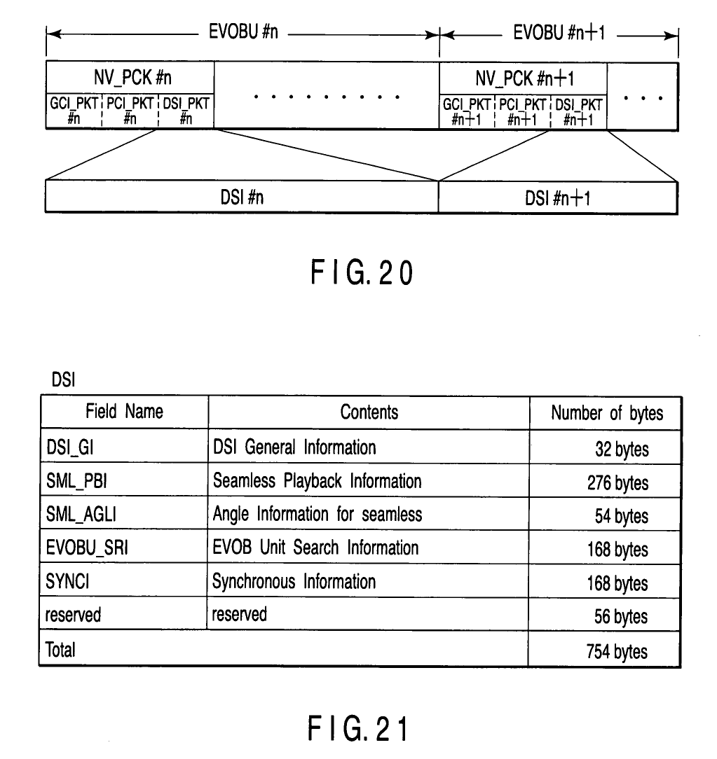

FIG. 20 shows a configuration of a navigation pack (NV_PCK). NV_PCK includes a general control information packet (GCI_PKT), a presentation control information packet (PCI_PKT), and a data search information packet (DSI_PKT).

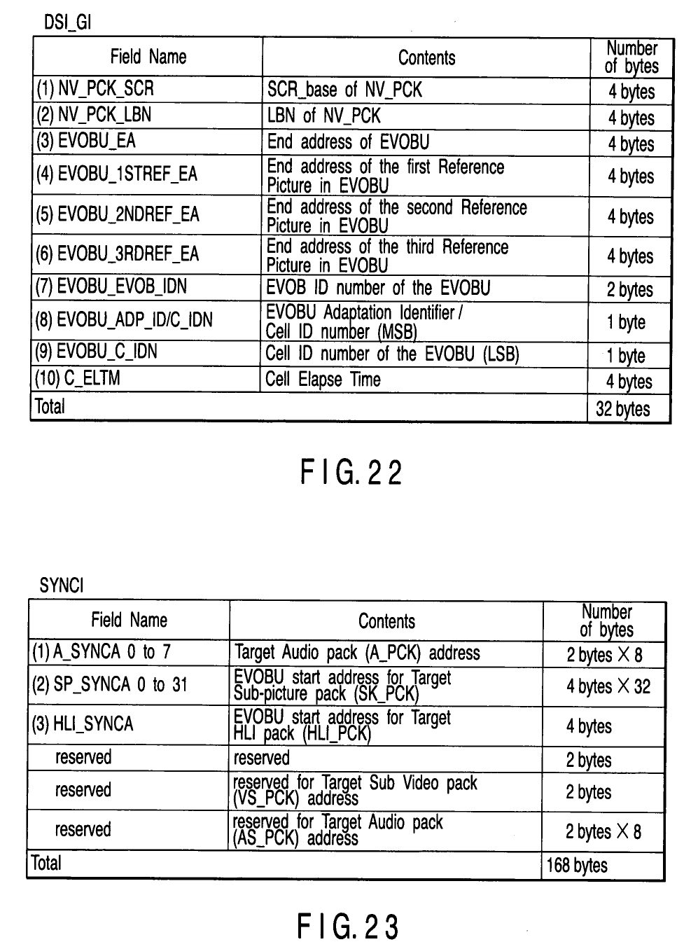

In the data search information packet (DSI_PKT), information as shown in FIG. 21 has been written. DSI_PKT includes DGI general information (DSI_GI), seamless playback information (SML_PBI), angle information for seamless (SML_AGLI), EVOB unit search information (EVOBU_SRI), and synchronous information (SYNCI). As shown in FIG. 22, DSI_GI includes a system clock reference of the navigation pack, the logical block number of the navigation pack from the head of EVOB, and the end address of EVOBU (the logical block number from the head of EVOB). DSI_GI further includes the end address of a first reference picture in EVOBU, the end address of a second reference picture, the end address of a third reference picture, and the ID number of EVOB in which EBOVU is included.

SML_PBI includes the category of seamless EVOBU, video start presentation time in EVOB, end presentation time, and others. SML_AGLI includes the address and size of the next interleave unit. In EVOBU_SRI, the addresses of the individual EVOBUs at −1, −2, −3, . . . , −240 ahead of NV_PAC and at +1, +2, +3, . . . , +240 behind NV_PAC have been written. When fast-forwarding or high-speed backward feeding is done, these addresses are used.

FIG. 23 shows the contents of SYNCI. In SYNCI, information on the packets in another EVOBU to be synchronized with the video in the EVOBU which includes the present navigation pack has been written. Specifically, the address of the target audio pack (A_PCK) is written (it can be written for each of eight streams). Moreover, the start address of EVOBU in which a target sub-picture pack (SP_PCK) exists has been written (it can be written for each of 32 streams). In addition, the start address of EVIBU in which a target highlight pack (HLT_PCK) exists has been written.

Consequently, recognizing the synchronous information, the playback apparatus can acquire SP_PCK and HLI_PCK in the preceding EVOBU when playing back the video data in the present EVOBU.

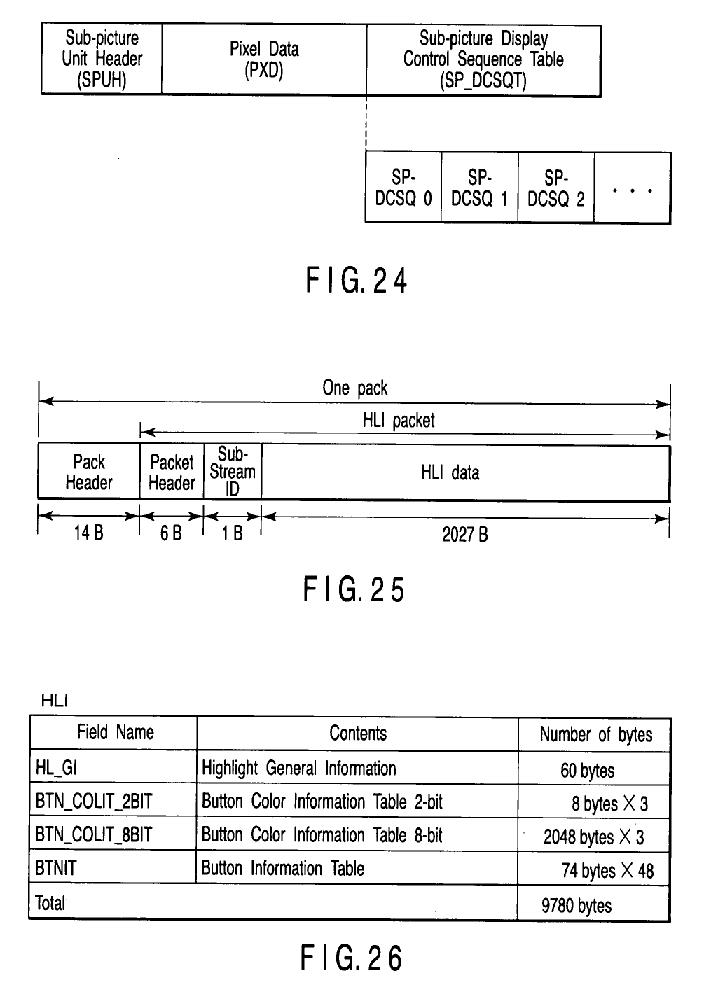

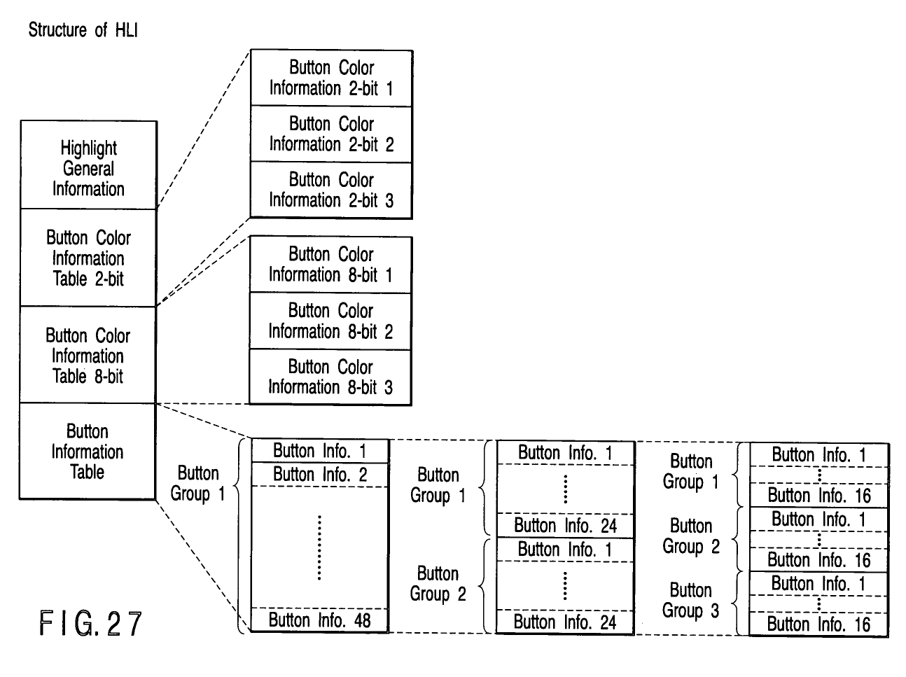

FIG. 24 shows an example of acquiring sub-picture data in a plurality of sub-picture packs and constructing a sub-picture unit. The sub-picture unit includes a sub-picture unit header, run-length-compressed pixel data, and a display control sequence table. Character and graphic display data can be obtained by decoding pixel data. The display timing on the screen, the size, colors, and others are controlled by display control commands written in a display control sequence table.

FIG. 25 shows a configuration of a highlight pack (e.g., containing 2048 bytes). The highlight pack includes a pack header, a packet header, a sub-stream ID indicating a highlight pack, and highlight information data (HLI data). Acquiring the data in the highlight pack makes it possible to create information as shown in FIG. 26.

FIG. 26 includes highlight general information (HL_GI), a button color information table (2 bits), a button color information table (8 bits), and a button information table. These bring the total to 9780 bytes. These pieces of information are divided into five packs, each containing 2048 bytes. Therefore, it is necessary to get the five highlight packs together to reproduce the data of FIG. 6. The reason why a table for button color information represented in eight bits has been prepared is to secure a wide range of colors using the table when high-resolution video is played back. Of course, a table for button color information represented in two bits may be used.

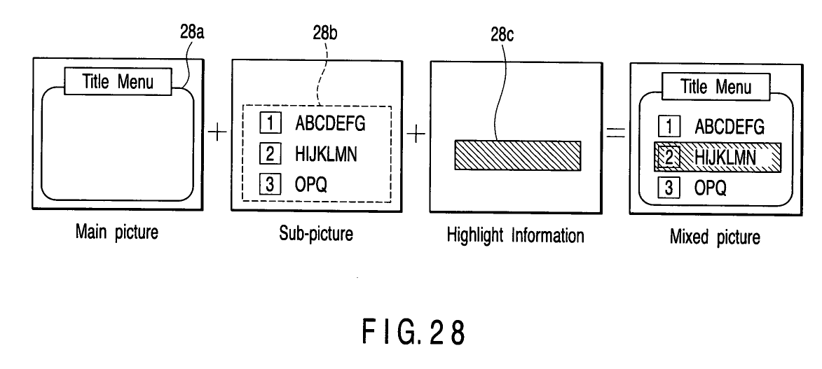

Written in HL_GI are a highlight information identifier, a highlight information status (indicating whether the present one is the same as the preceding one), the start presentation time and end presentation time of the highlight information, presentation time at which the display of the selected button is ended, presentation time in which a button command changes, and the number of button groups, the number of buttons. In the bottom color information table, color codes and contrast values have been written. In the button information table, display coordinate information on the button has been written for each button group. FIG. 28 schematically shows a main picture 28a is superimposed with a sub-picture 28b and highlight information 28c on the screen.

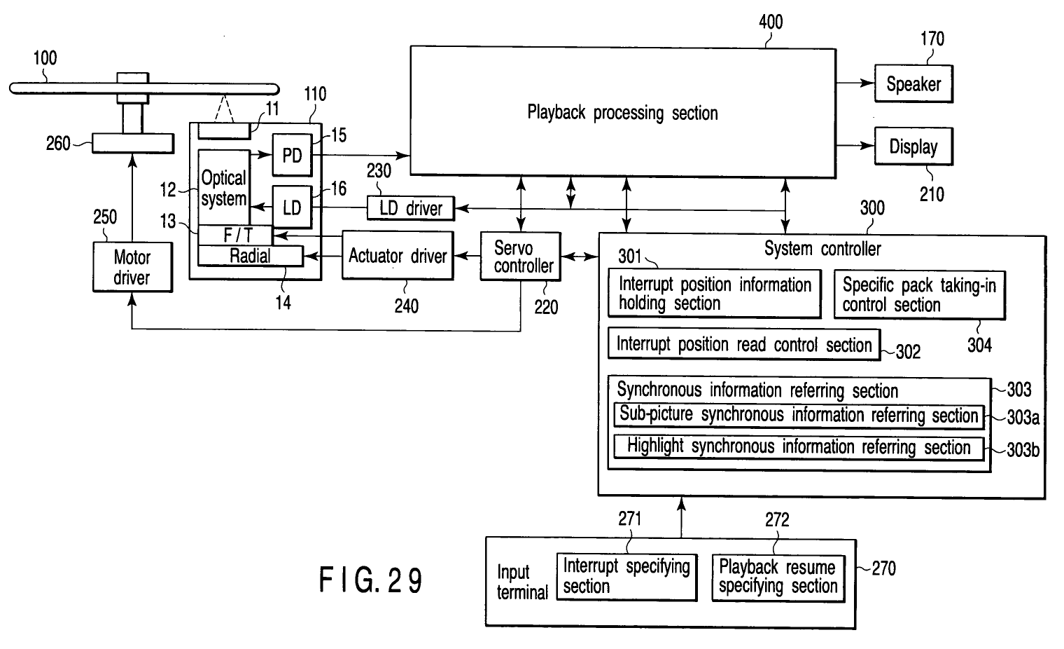

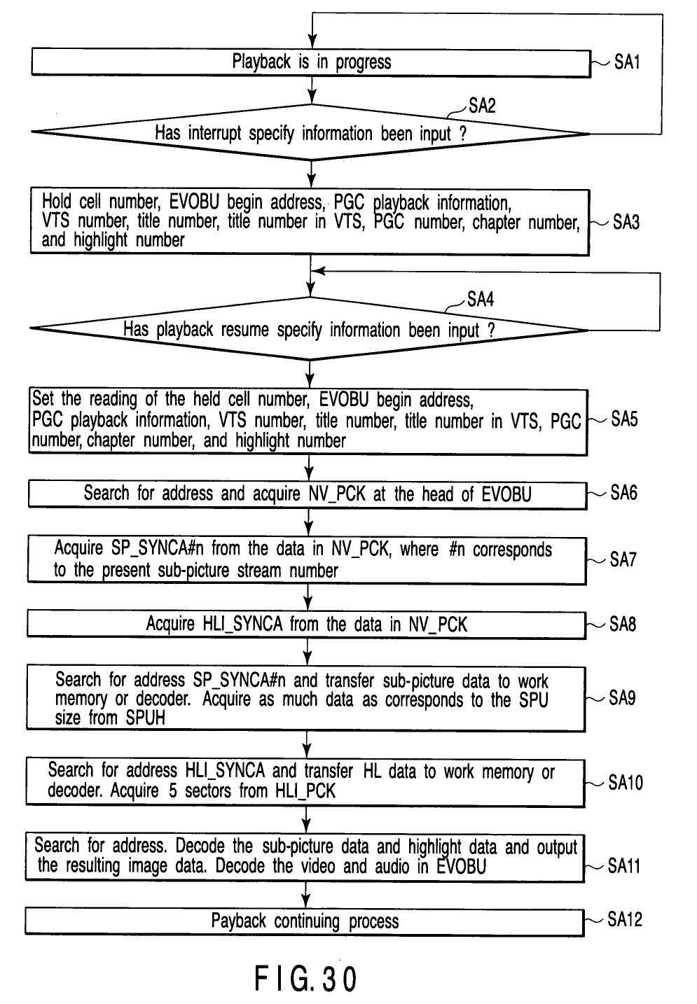

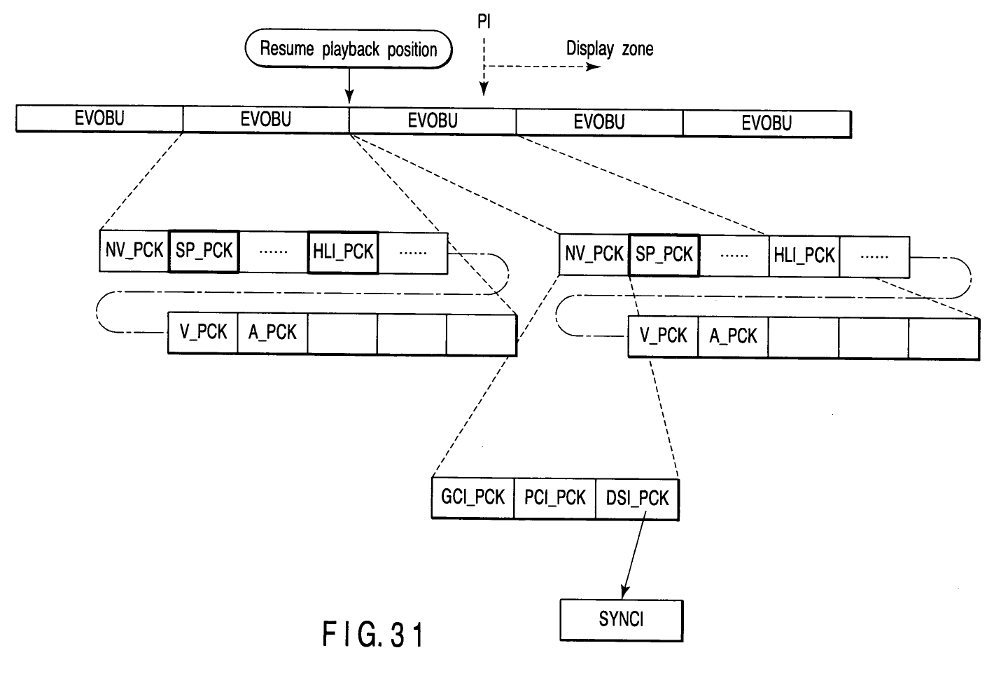

FIG. 29 shows a control block composed of an input terminal 270 and a system controller 300 to make the resume playback function clear. FIG. 30 is a flowchart to help explain the flow of signal processing when the resume playback function operates. FIG. 31 shows an example of particularly noticeable packs on the disc.

The input terminal 270, such as a remote controller, includes an interrupt specifying section 271 for specifying the interruption of playback and a playback resume specifying section 272 (play button) for specifying the resumption of playback after the interruption. The system controller 300 includes an interrupt position information holding section 301 for holding interrupt position information on the interrupt position on the disc, when an interrupt instruction is given in response to the operation input, and an interrupt position read control section 302 for reading a specific management information pack (NV_PCK) in the interrupt position on the basis of the interrupt position information. The system controller 300 further includes a synchronous information referring section 303 for referring to synchronous information included in the management information pack (NV_PCK) and a specific pack taking-in control section 304 for taking in a specific pack from a position ahead of the interrupt position, referring to the synchronous information. After the specific pack has been taken in, a playback processing section 400 reproduces not only the data in the specific pack but also data in the pack from the interrupt position.

The playback processing section 400 includes the regenerative amplifier 120, the signal processing section 130, the data processing section 140, the audio decoder 150, the video decoder 190, and the amplifiers 160, 200.

Referring to FIGS. 30 and 31, operations will be further explained. Suppose interrupt information has been input from the input terminal 270 (step SA2) during the playback of the disc (step SA1). It is assumed that the playback position when an interrupt instruction has been given is at point P1 of FIG. 31 on the disc.

At this time, the system controller 300 holds the cell number during playback, the EVOBU begin address during playback, and program chain (PGC) playback information (FIGS. 12, 13, 14, and 15).

The system controller 300 further holds the video title set (VTS) number and title number (corresponding to the unit number) during playback (FIG. 7). The system controller 300 further holds the title number in the title set (title unit number (FIG. 9)), the number of the program chain that is playing back this title (FIG. 12), the chapter number (corresponding to the part-of-search pointer number of FIG. 9), and the highlight number (the present highlight button number when it is being operated).

Next, suppose a playback resume instruction has been given (step SA4). Then, after a specific check is made (e.g., the disc is checked), the held information is read and set as system parameters.

Then, the apparatus searches for the EVOBU begin address and acquires NV_PCK at the head of EVOBU. In NV_PCK, synchronous information (SYNCI) shown in FIGS. 21 and 23 has been written. From the synchronous information, related sub-picture packs, highlight information packs, audio packs, and others in the preceding EVOBU are acquired. Then, the data in these packs are stored in a work memory or decoded at a decoder, which then outputs the result (step SA5 to step SA11). Moreover, the video data and audio data in EVOBU from which NV_PCK has been acquired are decoded and played back (step SA12).

As described above, when playback is resumed after the playback is interrupted, highlights and sub-pictures are particularly played back accurately. That is, highlight information is played back accurately with the timing expected by the video producer, thereby enabling a reliable apparatus to be provided. Moreover, highlight information is handled by a packet insertion method, thereby increasing the amount of data, which enhances the highlight display capability in terms of resolution and color representation. In addition, the highlight information area may be used for not only highlights but also other text information.

This invention is not limited to the above embodiment and may be embodied by modifying the component elements, which comprise another embodiments, without departing from the spirit or essential character thereof. In addition, various inventions may be formed by combining suitably a plurality of component elements disclosed in the embodiment. For example, some components may be removed from all of the component elements constituting the embodiment.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information recording medium playback apparatus comprising:
an interrupt specifying section which specifies the interruption of playback of the contents of a disc;
an interrupt position information holding section which holds interrupt position information on the interrupt position on the disc when the interrupt specifying section has given an interrupt instruction;
a playback resume specifying section which gives a playback resume instruction after the interruption;
an interrupt position read control section which, when the playback resume instruction has been given, accesses the interrupt position on the basis of the interrupt position information and reads a specific management information pack;
a synchronous information referring section which refers to synchronous information included in the management information pack;
a specific pack taking-in control section which takes in a specific pack from a position ahead of the interrupt position, referring to the synchronous information; and
a playback processing section which, after the specific pack has been taken in, reproduces not only the data in the specific pack but also the data in the pack from the interrupt position.

2. The information recording medium playback apparatus according to claim 1, wherein the specific pack taking-in section takes in a highlight pack as the specific pack.

3. The information recording medium playback apparatus according to claim 2, wherein the specific pack taking-in section further takes in a sub-picture pack as the specific pack.

4. The information recording medium playback apparatus according to claim 1, wherein the management information pack is a navigation pack located at the head of an enhanced video object unit composed of a plurality of packs.

5. An information recording medium playback method which has a read section for reading the contents of a disc, a playback processing section for processing the data in a pack train taken in from the read section, a controller, and an operation input section and reproduces video information, the information recording medium playback method comprising:
holding interrupt position information on the interrupt position on the disc when the operation input section has given an instruction to interrupt the playback of the contents of the disc;
when a playback resume instruction has been given, accessing the interrupt position on the basis of the interrupt position information and reading a specific management information pack;
referring to synchronous information included in the management information pack;
taking in a specific pack from a position ahead of the interrupt position, referring to the synchronous information; and
after the specific pack has been taken in, reproducing not only the data in the specific pack but also the data in the pack from the interrupt position.

6. The information recording medium playback method according to claim 5, further comprising: taking in a highlight pack as the specific pack.

7. The information recording medium playback method according to claim 6, further comprising: further taking in a sub-picture pack as the specific pack.

8. The information recording medium playback method according to claim 5, further comprising: taking in a navigation pack located at the head of an enhanced video object unit composed of a plurality of packs as the specific management information pack.

9. An information recording medium comprising:
enhanced video object units arranged so as to form a stream, each of which includes a navigation pack at its head and further includes a plurality of video packs, a plurality of audio packs, a plurality of sub-picture packs, and a plurality of highlight packs in that order, the navigation pack having synchronous information written therein, and the synchronous information having a start address written therein of the preceding enhanced video object unit including a plurality of highlight packs related to the video of the enhanced video object unit to which the synchronous information belongs.

10. The information recording medium according to claim 9, wherein the synchronous information has a start address written therein of the preceding enhanced video object unit including a plurality of sub-picture packs related to the video of the enhanced video object unit to which the synchronous information belongs.
